(19) United States
(12) Patent Application Publication
(10) Pub. No.: US 2006/0156339 A1
(43) Pub. Date: Jul. 13, 2006

(54) Electric program guide receiving apparatus, digital television system, and electronic apparatus

(75) Inventor: Takashi Ozawa, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/312,766

(22) Filed: Dec. 21, 2005

(30) Foreign Application Priority Data
Jan. 12, 2005 (JP) 2005-005082

(51) Int. Cl. H04N 5/445; G06F 3/00; G06F 13/00

(52) U.S. Cl. 725/46; 725/45

(57) ABSTRACT

An EPG (Electric Program Guide) receiving apparatus includes a tuner for tuning a received digital-broadcast signal, a storage device for storing partial or entire program titles and abbreviated character strings corresponding to the partial or entire program titles, and an EPG information processing device. The EPG information processing device compares the partial or entire program titles stored in the storage device with information of a target portion of an electric program guide included in the received digital-broadcast signal tuned by the tuner. The EPG information processing device further retrieves, from the partial or entire program titles stored in the storage device, an abbreviated character string corresponding to a partial or entire program title included in the target portion of an EPG. Then, the EPG information processing device generates information of the EPG including, if any, the abbreviated character string in replacement of information of the target portion of the EPG.

The entire disclosure of Japanese Patent Application No. 2005-005082, filed Jan. 12, 2005, is expressly incorporated by reference herein.

### BACKGROUND OF THE INVENTION

1. Field of the Invention

The present invention relates to an electric program guide receiving apparatus, a digital television system, and an electronic apparatus, and particularly to an electric program guide receiving apparatus, a digital television system, and an electronic apparatus for displaying an electric program guide (hereinafter referred to as EPG).

2. Description of the Related Art

In recent years, television broadcasting services have been diversified into various kinds, such as BS (Broadcasting Satellite) digital broadcasting, CS (Communication Satellite) digital broadcasting, and terrestrial digital broadcasting. In these digital broadcasting services, a viewer can receive the EPG. The EPG can be displayed by a digital television system, for example. The EPG shows broadcast programs ordered by broadcast time, according to a broadcast station. In a case that a program title is too long to fit in a cell (i.e., a display field) of the EPG, a portion of the program title exceeding the size of the cell may not be displayed.

In light of the above, the length of a cell in the EPG is changed for the program title too long to fit in the cell, as described in the Japanese Unexamined Patent Application Publication No. 10-28244, for example.

If the length of the cell is changed to display the entire program title in the cell, the cell size increases. As a result, the number of programs and television channels displayed in one screen decreases.

### SUMMARY

Accordingly, it is an object of the present invention to provide an electric program guide receiving apparatus, a digital television system, and an electronic apparatus, capable of displaying a relatively long program title without decreasing the number of programs and channels displayed in one screen.

The present invention describes an electric program guide receiving apparatus. According to one aspect of the invention, an electric program guide receiving apparatus includes a tuner, a storage device, and an electric program guide information processing device. The tuner tunes a received digital-broadcast signal. The storage device stores partial or entire program titles and abbreviated character strings corresponding to the partial or entire program titles. The electric program guide information processing device compares the partial or entire program titles stored in the storage device with information of a target portion of an electric program guide included in the received digital-broadcast signal tuned by the tuner. Then, the electric program guide information processing device retrieves, via the partial or entire program titles stored in the storage device, an abbreviated character string corresponding to a partial or entire program title included in the target portion of an electric program guide, and generates information of the electric program guide including, if any, the abbreviated character string in replacement of information of the target portion of the electric program guide. According to the one aspect of the invention, an abbreviated character string representing a part or the entirety of a relatively long program title is registered in the storage device, so that the abbreviated character string corresponding to the relatively long program title is used in displaying the electric program guide. Thus configured, the electric program guide receiving apparatus according to the one aspect of the invention can prevent undesirable reduction in the number of programs and channels displayed in one screen.

The present invention further describes a digital television system. According to one aspect of the invention, a digital television system includes a tuner, a display device, a storage device, and an electric program guide information processing device. The tuner tunes a received digital-broadcast signal. The storage device stores partial or entire program titles and abbreviated character strings corresponding to the partial or entire program titles. The electric program guide information processing device compares the partial or entire program titles stored in the storage device with information of a target portion of an electric program guide included in the received digital-broadcast signal tuned by the tuner. Then the electric program guide information processing device retrieves, via the partial or entire program titles stored in the storage device, an abbreviated character string corresponding to a partial or entire program title included in the target portion of an electric program guide, and generates information of the electric program guide including, if any, the abbreviated character string in replacement of information of the target portion of the electric program guide. Further, the electric program guide information processing device causes the display device to display the information of the electric program guide. As described above, in the digital television system according to the one aspect of the invention, an abbreviated character string representing a relatively long program title is registered in the storage device so that the abbreviated character string is used in displaying the electric program guide. Thus configured, the digital television system according to the one aspect of the invention can prevent undesirable reduction in the number of programs and channels displayed in one screen.

The digital television system according to the one aspect of the invention may further include an operation device for inputting a variety of operation signals. When the operation device specifies a program in the electric program guide displayed on the display device, the electric program guide processing device may cause the display device to display information of the program including an unabbreviated title of the program. In the digital television system according to the one aspect of the invention, when a program in the electric program guide displayed on the display device is specified through operation of the operation device, information of the specified program including an original unabbreviated character string of the program title is displayed on the display device. Therefore, a user can visually compare the abbreviated program title with the original unabbreviated program title. Accordingly, the user can relatively easily obtain information of an abbreviated character string of a program title, even if the user does not know what the abbreviated character string represents.

In the digital television system according to the one aspect of the invention, the electric program guide processing device may cause the display device to display, in a margin outside the electric program guide, the information of the program including the unabbreviated title of the program.

The present invention further describes an electronic apparatus. According to a first aspect of the invention, an electronic apparatus includes the electric program guide receiving apparatus described above or the digital television system described above.

### BRIEF DESCRIPTION OF THE DRAWINGS

FIG. 1 is a block diagram illustrating a configuration of a digital television system according to an embodiment of the present invention.

FIG. 2 is a front view of a remote controller illustrated in FIG. 1.

FIG. 3 is a table including preset information stored in an abbreviated character string registration/storage part illustrated in FIG. 1.

FIG. 4 is a flowchart illustrating an operation performed by an EPG information processing part illustrated in FIG. 1.

FIG. 5A is an example of an EPG displayed on one screen according to an embodiment of the present invention.

FIG. 5B is an example of an EPG displayed on one screen not according to an embodiment of the present invention.

FIG. 6 is a flowchart illustrating another operation performed by the EPG information processing part illustrated in FIG. 1.

### DESCRIPTION OF THE PREFERRED EMBODIMENTS

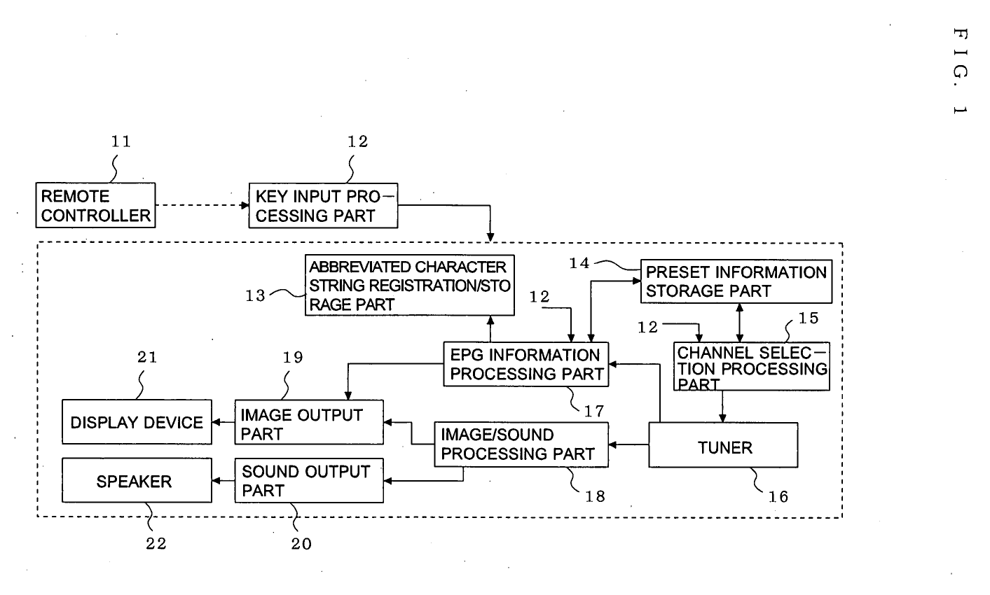

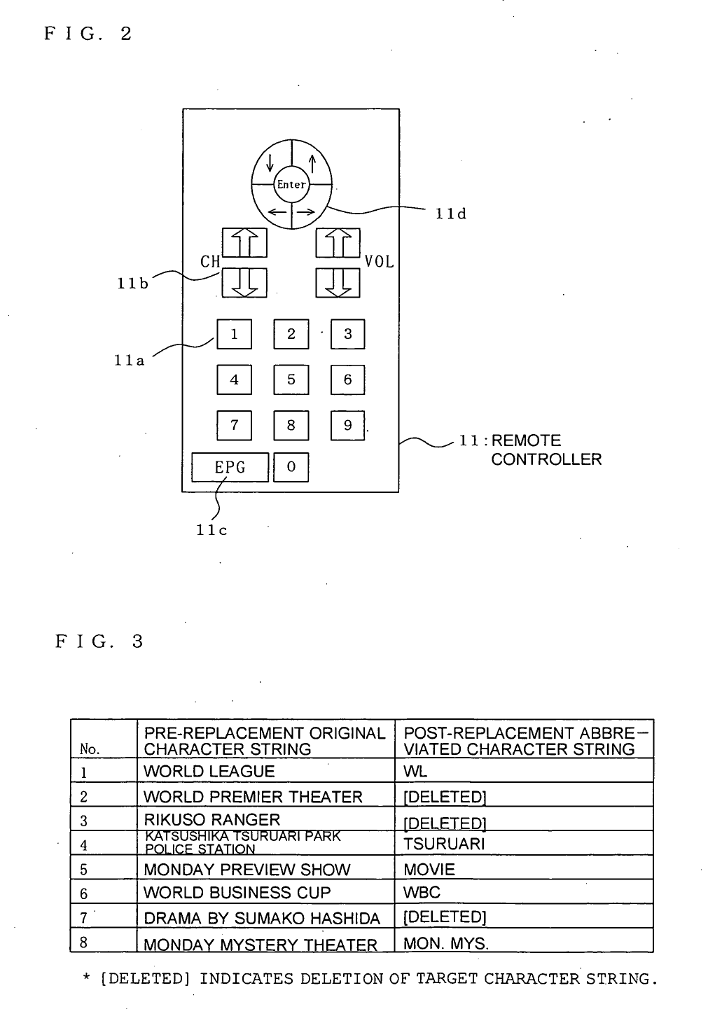

FIG. 1 is a block diagram illustrating a configuration of a digital television system according to an embodiment of the present invention. The digital television system includes an electric program guide receiving apparatus according to an embodiment of the present invention. As illustrated in FIG. 1, the digital television system according to the present embodiment includes a remote controller 11, a key input processing part 12, an abbreviated character string registration/storage part 13, a preset information storage part 14, a channel selection processing part 15, a tuner 16, an EPG information processing part 17, an image/sound processing part 18, an image output part 19, a sound output part 20, a display device 21, and a speaker 22. The remote controller 11 is operated by a user (i.e., a viewer), and includes a variety of buttons, such as channel selection buttons (e.g., direct channel selection buttons and up-and-down channel selection buttons) and EPG buttons for displaying the EPG, as later described with reference to FIG. 2. The key input processing part 12 analyzes an operation signal sent from the remote controller 11, and outputs a control signal according to the operation signal. The abbreviated character string registration/storage part 13 stores a pair of a pre-replacement original character string and a post-replacement abbreviated character string, as later described with reference to FIG. 3. The preset information storage part 14 stores information of a relationship between the direct channel selection buttons and channels.

When a user specifies a target channel by operating the channel selection buttons of the remote controller 11, the channel selection processing part 15 receives information of the target channel through the key input processing part 12. Then, the channel selection processing part 15 outputs a channel selection signal in accordance with data stored in the preset information storage part 14. The tuner 16 sets a channel according to the channel selection signal. The tuner 16 is connected to an antenna (not illustrated), for example. The antenna, which includes a frequency converter, receives a digital broadcast signal sent from a CS (Communication Satellite) and outputs a frequency-converted signal to the tuner 16. The tuner 16 includes a demodulator circuit, an inverse interleaver circuit, an error corrector circuit, and so forth, and performs an operation of retrieving a signal of a predetermined frequency from high-frequency digital modulated signals including image/sound data. That is, the tuner 16 performs an operation of selecting one of a plurality of transponders for digital broadcasting. The image/sound processing part 18 includes a demultiplexer, a video decoder, an audio decoder, and so forth. The image/sound processing part 18 separates a transport stream into such streams as a video stream and an audio stream of an MPEG2 Format (Moving Picture Experts Group 2), for example. As for the video stream, the image/sound processing part 18 processes the video stream by using the video decoder, and calculates a quantization coefficient and a motion vector by decoding an input variable-length code. Further, the image/sound processing part 18 performs such operations as an IDCT (inverse discrete cosine transform) and a motion compensation control on the basis of the motion vector, and outputs an image signal to the image output part 19. On the basis of the image signal sent from the image/sound processing part 18, the image output part 19 generates another image signal for displaying an image on the display device 21. The image output part 19 includes, for example, a scaler/OSD (On Screen Display) processor circuit, a frame memory, and so forth. Thus, for example, the image output part 19 generates and stores, in the frame memory, a frame image for each frame, reads out the frame image (i.e., the image signal), performs a D/A (digital-to-analog) conversion to the image signal, converts the image signal into a composite image signal, for example, and outputs the composite image signal to the display device 21. Then, the display device 21 displays a television image according to the image signal.

As for the audio stream generated by the image/sound processing part 18, on the other hand, the video decoder decodes an input encoded signal, generates an audio signal (i.e., audio data), and outputs the audio signal to the sound output part 20. The sound output part 20 performs the D/A conversion to the audio signal, generates an analog signal of a right (R)-speaker sound and an analog signal of a left. (L)-speaker sound, amplifies the analog signals, and outputs the amplified analog signals to the speaker 22. As a result, a sound is output from the speaker 22.

When a user operates buttons of the remote controller 11 for displaying an electric program, the EPG information processing part 17 receives information sent from the remote controller 11 through the key input processing part 12. The EPG information processing part 17 further receives, from the transport stream output from the tuner 16, information of a target portion of the EPG to be displayed on the display device 21. The information is included in a PSI/SI (Program Specific Information/Service Information). Then, the EPG information processing part 17 obtains an abbreviated character string, which relates to the received information (i.e., the title of the program), from the abbreviated character string registration/storage part 13, and outputs the abbreviated character to the image processing part 19. The information of the target portion of the EPG may be alternatively received from the demultiplexer of the image/sound processing part 18. The image output part 19 generates, through the OSD processing circuit included therein, the image signal of the EPG such that an image currently displayed on the display device 21 is overwritten with the target portion of the EPG. Accordingly, the target portion of the EPG is displayed on the display device 21.

As described above, when a user selects a channel by operating the remote controller 11, a signal indicating the selected channel is output to the tuner 16 through the key input processing part 12 and the channel selection processing part 15. Then, a transponder corresponding to the selected channel is selected by the tuner 16, and the signal indicating the selected channel is output to the image output part 19 and the sound output part 20 through the image/sound processing part 18. The image output part 19 performs the above-described signal processing for displaying, on the display device 21, an image sent by the selected channel. Meanwhile, the sound output part 20 causes the speaker 22 to output a sound sent by the selected channel.

FIG. 2 is a front view of the remote controller 11. The remote controller 11 includes a variety of buttons (i.e., keys), such as the direct channel selection buttons (i.e., number keys) 11a, the up-and-down channel selection buttons 11b, the EPG buttons 11c, and shift buttons 11d. The key input processing part 12 receives an operation signal sent from the remote controller 11, and outputs a signal according to the operation signal to the channel selection processing part 15 and the EPG information processing part 17, for example.

FIG. 3 is a table, stored in the abbreviated character string registration/storage part 13, representing respective relationships between pre-replacement original character strings and their post-replacement abbreviated character strings. For example, a program title “WORLD LEAGUE” is abbreviated to “WL,” and program tiles “WORLD PREMIER THEATER” and “RIKUSO RANGER” are deleted. Other program titles “KATSUSHIKA TSURUARI PARK POLICE STATION,” “MONDAY PREVIEW SHOW,” and “WORLD BUSINESS CUP” are abbreviated to “TSURUARI,” “MOVIE,” and “WBC,” respectively. In this way, samples of abbreviated or deleted character strings are set and registered in advance. The abbreviated character string registration/storage part 13 forms a storage device according to an embodiment of the present invention.

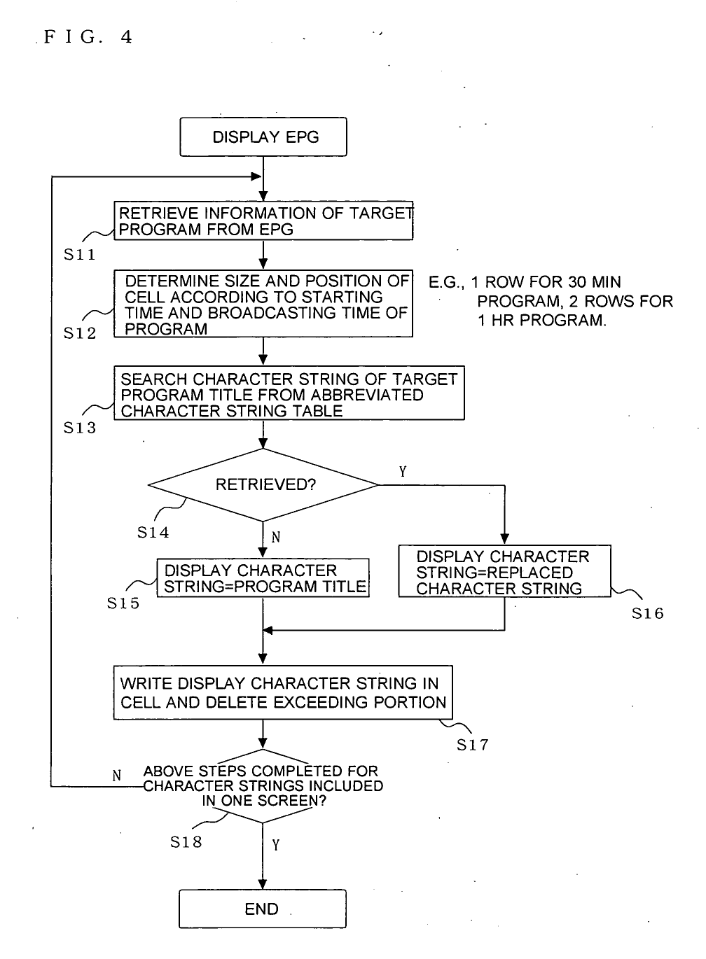

FIG. 4 is a flowchart illustrating an operation performed by the EPG information processing part 17. When a user presses the EPG button 11c of the remote controller 11, the EPG information processing part 17 starts an operation of displaying the EPG and retrieves information of a target portion of the EPG from information of the EPG sent from the tuner 16 (Step S11). In the present embodiment, for example, the target portion of the EPG refers to a portion of the EPG showing programs broadcasted by a few television channels including a currently-selected channel. Then, a size and a position of each of the cells forming the target portion of the EPG are determined on the basis of a starting time and a broadcasting time period of each program (Step S12). For example, a single row is used for displaying a thirty-minute program, while two rows are used for displaying a one-hour program. The width of each of the cells is determined according to the number of channels displayed in the target portion of the EPG. Then, a character string forming a program title (i.e., program name) included in the target portion of the EPG is searched from the table shown in FIG. 3, which includes a group of abbreviated character strings (Step S13). It is thus determined whether the table includes a character string forming the program title included in the target portion of the EPG (Step S14). If it is determined that the table does not include the character string forming the program title included in the target portion of the EPG (NO in Step S14), the original program title is identified as a display character string (i.e., a character string to be displayed in a cell) (Step S15). Meanwhile, if it is determined that the table includes the character string forming the program title included in the target portion of the EPG (YES in Step S14), an abbreviated character string of the character string forming the program title is identified as the display character string (Step S16). The display character string thus identified is written in a cell. If the entire display character string is too long to fit in the cell, a portion of the display character string exceeding the cell is omitted (Step S17). The above steps of S11 to S17 are performed for each character string forming the target portion of the EPG displayed on one screen (Step S18). Then, upon receipt of data of the target portion of the EPG, the image output part 19 processes the data by using the OSD processing circuit included therein (not illustrated). Accordingly, an image currently displayed on the display device 21 is overwritten with an image of the target portion of the EPG, so that the target portion of the EPG is displayed on the display device 21.

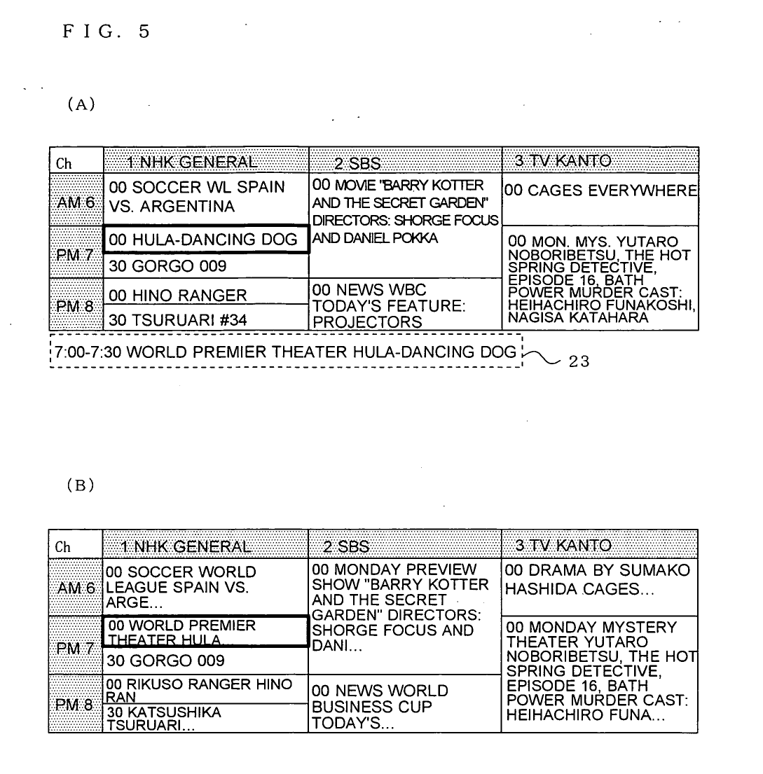

FIGS. 5A and 5B are diagrams showing examples of the EPG displayed on the display device 21, respectively with and without performing the operation illustrated in FIG. 4. As is seen from comparison of FIG. 5A with FIG. 5B, a character string “SOCCER WORLD LEAGUE” displayed in FIG. 5B is abbreviated to “WL” in FIG. 5A, and character strings “WORLD PREMIER THEATER” and “RIKUSO RANGER” displayed in FIG. 5B are deleted in FIG. 5A.

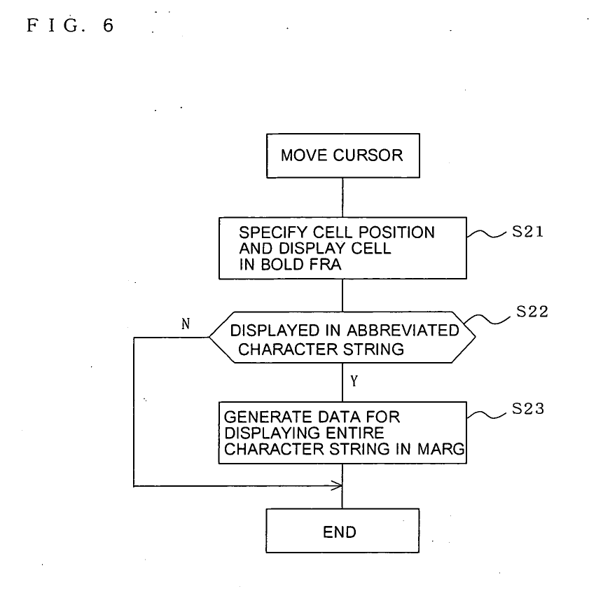

FIG. 6 is a flowchart illustrating an operation performed by the EPG information processing part 17 when a user operates the remote controller 11 and moves a cursor on a screen of the display device 21 displaying the EPG shown in FIG. 5A. When the user operates the shift buttons 11d of the remote controller 11, the EPG information processing part 17 receives, through the key input processing part 12, an operation signal sent from the remote controller 11. Thus, the EPG information processing part 17 detects movement of the cursor, determines the position of the moved cursor, and displays a cell to which the cursor has moved in a bold-line frame (Step S21). With reference to the table shown in FIG. 3, the EPG information processing part 17 then determines whether the cell displayed in a bold-line frame includes any abbreviated character string (Step S22). If it is determined that the cell includes any abbreviated character string (YES in Step S22), the post-replacement abbreviated character string is converted into a pre-replacement original character string. Then, data is generated for displaying the pre-replacement original character string at a predetermined position 23 in a margin outside the EPG (see a lower part of FIG. 5A), and the data is displayed on the display device 21 through the image output part 19 (Step S23). In the example shown in FIG. 5A, the cursor is placed on a cell showing a character string “THE HULA-DANCING DOG,” and the entirety of its pre-replacement original character string “7:00-7:30 WORLD PREMIER THEATER THE HULA-DANCING DOG” is displayed.

As described above, in the digital television system according to the present embodiment, the abbreviated character string representing a part or the entirety of a relatively long program title is registered and stored in the abbreviated character string registration/storage part 13, so that the abbreviated character string is used in the EPG displayed on the display device 21. Thus configured, the digital television system according to the present embodiment can prevent undesirable reduction in the number of programs and channels displayed in one screen of the EPG. Further, when a program in the EPG displayed on the display device 21 is specified through operation of the remote controller 11, information of the specified program including the pre-replacement original character string of the program title is displayed on the display device 21. Therefore, a user can visually compare the abbreviated program title with the original unabbreviated program title. Accordingly, the user can relatively easily obtain information of an abbreviated character string of a program title, even if the user does not know what the abbreviated character string represents.

In the digital television system according to the present embodiment, the remote controller 11 is used as an example of an operation device. Alternatively, buttons (i.e., keys) provided on the digital television system may be used, as the operation device, in replacement of or in combination with the remote controller 11. Further, in the digital television system according to the present embodiment, the number of channels included in the displayed EPG is set to be three. Alternatively, the number of the channels may be set to be an arbitrary value, and may be also set according to a size of the screen of the display device 21. Further, the digital television system according to the present embodiment does not exclude, but instead includes, functions of existing digital television systems along with functions of the digital television system according to the present embodiment. Furthermore, data stored in the preset information storage part 14 can be arbitrarily changed through operation of the remote controller 11, and can register and store abbreviated character strings according to preferences of each individual user.

An electric program guide receiving apparatus according to an embodiment of the present invention includes the remote controller 11, the key input processing part 12, the abbreviated character string registration/storage part 13, the preset information storage part 14, the channel selection processing part 15, the tuner 16, and the EPG information processing part 17. The thus configured electric program guide receiving apparatus can be applied to an electronic apparatus, such as a digital tuner built-in apparatus, for example. Further, with the component members shown in FIG. 1 excluding the display device 21 and the speaker 22, the electric program guide receiving apparatus according to the present embodiment may be used for forming a television recorder, such as a DVD (Digital Versatile Disc) recorder, for example. Furthermore, the electric program guide receiving apparatus according to the present embodiment may be applied to a complex apparatus including the entirety of the digital television system shown in FIG. 1. For example, the electric program guide receiving apparatus according to the present embodiment is particularly useful in an electronic apparatus having a relatively small screen, such as a mobile phone, for example.

1. An electric program guide receiving apparatus comprising:
a tuner for tuning a received digital-broadcast signal;
a storage device for storing partial or entire program titles and abbreviated character strings corresponding to the partial or entire program titles; and
electric program guide information processing means for comparing the partial or entire program titles stored in the storage device with information of a display target portion of an electric program guide included in the received digital-broadcast signal tuned by the tuner, retrieving, from the partial or entire program titles stored in the storage device, an abbreviated character string corresponding to a partial or entire program title included in the target portion of an electric program guide, and generating information of the electric program guide including, if any, the abbreviated character string in replacement of information of the target portion of the electric program guide.

2. A digital television system, comprising:
a tuner for tuning a received digital-broadcast signal;
a display device;
a storage device for storing partial or entire program titles and abbreviated character strings corresponding to the partial or entire program titles; and
electric program guide information processing device for comparing the partial or entire program titles stored in the storage device with information of a display target portion of an electric program guide included in the received digital-broadcast signal tuned by the tuner, retrieving, from the partial or entire program titles stored in the storage device, an abbreviated character string corresponding to a partial or entire program title included in the target portion of an electric program guide, generating information of the electric program guide including, if any, the abbreviated character string in replacement of information of the target portion of the electric program guide, and causing the display device to display the information of the electric program guide.

3. The digital television system according to claim 2, further comprising:
an operation device for inputting a variety of operation signals,
wherein, when the operation device specifies a program in the electric program guide displayed on the display device, the electric program guide processing device causes the display device to display information of the specified program including a partial or an entire program title corresponding to an abbreviated character string included in the specified program.

4. The digital television system according to claim 3,
wherein the electric program guide processing device causes the display device to display, in a margin outside the electric program guide, the information of the specified program.

5. An electronic apparatus comprising:
the electric program guide receiving apparatus according to claim 1.

6. An electronic apparatus comprising:
the digital television system according to claim 2.

7. An electronic apparatus comprising:
the digital television system according to claim 3.

8. An electronic apparatus comprising:
the digital television system according to claim 4.
